(19) United States
(12) Patent Application Publication
(10) Pub. No.: US 2016/0145060 A1
(43) Pub. Date: May 26, 2016

(54) IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: Masahiro Ohno, Yokohama (JP)

(21) Appl. No.: 14/548,592

(22) Filed: Nov. 20, 2014

(51) Int. Cl. B65H 1/14; B65H 1/04; B65H 43/02; B65H 3/06; B65H 7/04; B65H 35/06; G03G 15/00; B65H 1/26

(52) U.S. Cl. CPC B65H 1/14; G03G 15/6511; B65H 1/04; B65H 1/266; B65H 3/0684; B65H 7/04; B65H 35/06; B65H 43/02

(57) ABSTRACT

In accordance with one embodiment, an image forming apparatus comprises a paper feed cassette configured to include a tray which is capable of placing paper housed in a packaging member one end of which is opened together with the packaging member; a paper feed section configured to include a pickup roller which picks up the paper housed in the packaging member from the opened end of the packaging member; and a regulating member configured to regulate that the packaging member is conveyed from the tray.

### FIELD

Embodiments described herein relate generally to an image forming apparatus such as a copier and the like, which is capable of taking out the paper that is placed in a paper feed cassette in a state of being housed by a packaging member.

### BACKGROUND

Conventionally, in an image forming apparatus, a paper taken out from a paper feed cassette is conveyed to an image forming section to form an image on the paper. The paper is taken out from the cassette, thus, the cassette is provided with a pickup roller and a paper feed roller.

However, in the past, the paper is packaged by a packaging member such as the packing paper and the like. Thus, in a case in which a paper is to be stacked in a cassette, it is general to take out the paper from the packaging member and only set the paper in the cassette. In a case of stacking the paper in the cassette, it is necessary to set the paper in an aligned state by a side guide or an end guide.

In a case of setting failure since the paper is not aligned, the image to be printed on the paper may be shifted. In the case of setting failure, the leading end position of the paper may be shifted, and a lateral shift of paper or a slope (skew) of the paper may occur. Further, in the case of setting failure, a paper feeding error such as a paper jam and the like, a conveyance failure and the like may occur.

The paper that is packaged by the packaging member is generally packaged into one bundle with 250 or 500 sheets of paper as a unit. Thus, when taking out the paper bundle from the packaging member, the paper is disordered and the paper bundle is lost.

Thus, it is necessary to align the disordered paper. However, if there are 250 or 500 sheets of paper, it is not possible to align the paper well. Moreover, there is a possibility that the paper bundle may be set in the cassette in the state of not being aligned. When the paper bundle which is not be aligned is set, the image deviation in the print, the deviation of the leading end position of the paper, or the lateral shift or the slope (skew) of the paper and the like described above occurs.

It is also considered that the paper is set in the cassette in a state of being housed in the packaging member, a part of the packaging member is broke along a perforation, and the end part of the paper out of the packaging member is taken out by the pickup roller to convey the paper. However, in a case of setting the paper for each packaging member, the packaging member hung on the paper may be conveyed when the amount of the paper becomes less and less.

### BRIEF DESCRIPTION OF THE DRAWINGS

FIG. 1 is a diagram illustrating the constitution of an image forming apparatus according to one embodiment;

FIG. 2 is a perspective view illustrating an example of a paper feed cassette according to the embodiment;

FIG. 3 is a side view of the cassette before stacking paper therein according to the embodiment;

FIG. 4 is a side view of the cassette after stacking paper therein according to the embodiment;

FIG. 5A is a side view illustrating the constitutions of the cassette and a paper feed section according to the embodiment;

FIG. 5B is a perspective view illustrating the constitution of a packaging member for the paper according to the embodiment;

FIG. 6 is a perspective view illustrating a modification of the packaging member according to the embodiment;

FIG. 7 is a perspective view illustrating a state in which the front end part of the packaging member is opened in the modification;

FIG. 8 is a perspective view illustrating an another modification of the packaging member according to the embodiment;

FIG. 9 is a perspective view illustrating a state in which the front end part of the packaging member is opened in the another modification;

FIG. 10 is a side view illustrating the constitution of a holding member according to a second embodiment; and

FIG. 11 is a side view illustrating another constitution of the holding member according to the second embodiment.

### DETAILED DESCRIPTION

In accordance with one embodiment, an image forming apparatus comprises:

a paper feed cassette configured to include a tray which is capable of placing the paper housed in a packaging member one end of which is opened together with the packaging member;

a paper feed section configured to include a pickup roller which picks up the paper housed in the packaging member from the opened end part of the packaging member;

a regulating member configured to regulate that the packaging member is conveyed from the tray; and

an image forming section configured to form an image on the paper conveyed by the paper feed section.

Hereinafter, an image forming apparatus according to the embodiment is described in detail with reference to the accompanying drawings. Further, same components in each figure are applied with the same reference numerals.

### A First Embodiment

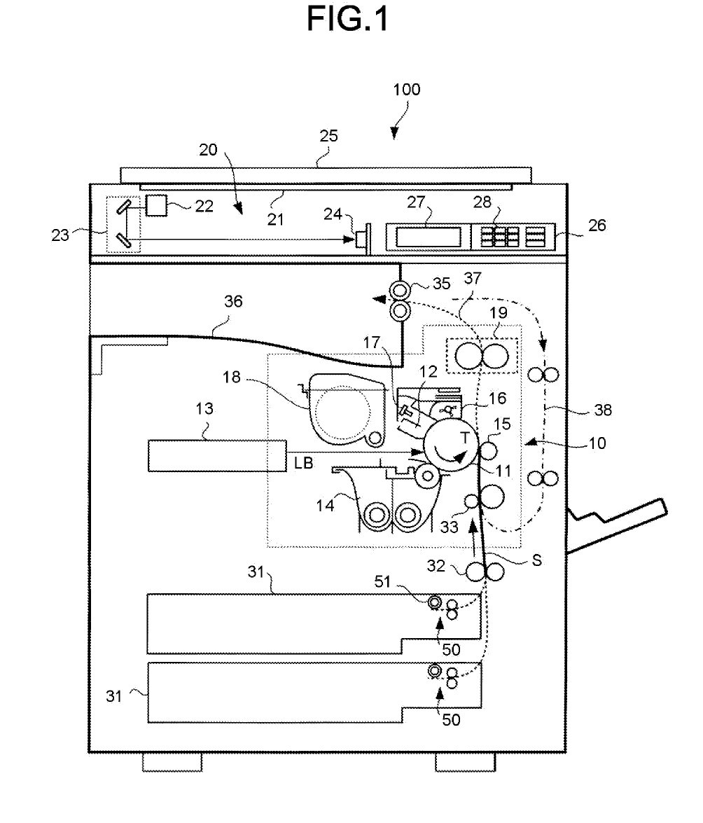

FIG. 1 is a diagram illustrating the constitution of the image forming apparatus according to the embodiment. In FIG. 1, an image forming apparatus 100 is an electrophotographic copier. The image forming apparatus 100 may be a printer, an MFP (Multi-Function Peripheral) and the like in addition to the copier. In the following description, the copier is exemplified.

The image forming apparatus (copier) 100 is provided with a printer section 10 at the central part thereof. The printer section 10 constitutes an image forming section. The printer section 10 is equipped with a photoconductive drum 11 which can rotate freely. The photoconductive drum 11, which is an image carrier, includes an Organic Photo conductor (OPC) on the outer periphery. If the photoconductive drum 11 is irradiated with light in a state in which given potential is applied to the photoconductive drum 11, the potential of an area irradiated with light changes and the change of potential is maintained for a given time as an electrostatic latent image.

An electrostatic charger 12, an exposure unit 13, a developer 14, a transfer roller 15, a drum cleaner 16 and a charge removing lamp 17 are arranged around the photoconductive drum 11 along a rotation direction T of the photoconductive drum 11.

The electrostatic charger 12 charges the surface of the photoconductive drum 11 to a given potential. The exposure unit 13 exposes the photoconductive drum 11 by irradiating the photoconductive drum 11 with laser beam LB to form an electrostatic latent image on the surface of the photoconductive drum 11. The laser beam LB changes the strength of the light according to the concentration of the image and the like.

The developer 14 stores two-component developing agent including carrier and toner, and supplies the developing agent to the surface of the photoconductive drum 11 to develop the electrostatic latent image of the photoconductive drum 11. The electrostatic latent image on the surface of the photoconductive drum 11 is visualized to form a toner image. The transfer roller 15 applies a given potential to a paper S serving as an image receiving medium to transfer the toner image on the photoconductive drum 11 to the paper S.

The drum cleaner 16 removes and collects the toner and the like left on the surface of the photoconductive drum 11. The charge removing lamp 17 removes the charge left on the photoconductive drum 11. Further, a fixing device 19 is arranged at the downstream side of the transfer roller 15. The fixing device 19 conveys the paper S in a state of being pressed and heated at a given temperature. The toner image is transferred to the paper S by the fixing device 19.

Further, a toner cartridge 18 for storing toner is arranged above the developer 14, and if the toner in the developer 14 is consumed, the developer 14 is replenished with toner from the toner cartridge 18.

On the other hand, a scanner section 20 is arranged at the upper portion of the image forming apparatus 100. The scanner section 20 includes a light source 22, a reflecting mirror 23 and an image sensor 24. The light source 22 irradiates the original placed on the original placing table 21 with light. The reflecting mirror 23 reflects the light reflected from the original. The image sensor 24 receives the light reflected from the reflecting mirror 23.

Further, an original cover 25 is arranged openably and closably above the original placing table 21. Moreover, an operation panel 26 is arranged nearby the scanner section 20. The operation panel 26 includes a touch panel type display section 27 and operational keys 28.

A paper feed cassette 31 is arranged at the lower portion of the image forming apparatus 100. A plurality of paper feed cassettes 31 may be arranged according to the size of paper. The paper S in the paper feed cassette 31 is picked up by a pickup roller 51. The picked up paper S is guided to the transfer roller 15 by a conveyance roller 32 and a register roller 33. The pickup roller 51 picks up the paper S in the paper feed cassette 31 one by one. To align the positions of the paper S and the toner image formed on the photoconductive drum 11, the conveyance roller 32 and the register roller 33 rotate at giving timing. The conveyance roller 32 and the register roller 33 convey the paper S to a transfer position. The paper S passing through the transfer roller 15 is conveyed to the fixing device 19. The paper S is discharged to a paper discharge tray 36 by a paper discharge roller 35 after it passed through the fixing device 19.

In a case of a simplex printing, the paper S is conveyed from the register roller 33 to the transfer roller 15. The paper S is further conveyed through a conveyance path 37 from the transfer roller 15 to the paper discharge roller 35 via the fixing device 19. Further, a reversal conveyance path 38 used when a duplex printing is carried out is also arranged. In a case of a duplex printing, the paper S is temporarily conveyed from the paper discharge roller 35 to the paper discharge tray 36. Then the paper S is switched back to be conveyed to the reversal conveyance path 38. The reversal conveyance path 38 is provided with a plurality of conveyance rollers to reverse the paper S and guide it to the register roller 33.

During the image forming process of the image forming apparatus 100 described above, the original placed on the original placing table 21 is irradiated with light from the light resource 22. The light reflected by the original enters the image sensor 24 through the reflecting mirror 23. Then the image sensor 24 reads an original image based on the entered light. A laser beam LB is output from the exposure unit 13 based on the information read by the image sensor 24 or the image information supplied from external device such as a PC (Personal Computer) and the like.

The laser beam LB is irradiated on the surface of the photoconductive drum 11. The surface of the photoconductive drum 11 is negatively charged by the charging charger 12. Thus, the laser beam LB is irradiated from the exposure unit 13 to expose the photoconductive drum 11, and then the electrostatic latent image is formed on the surface of the photoconductive drum 11.

Then if the paper S taken out from the paper feed cassette 31 is conveyed, the toner image on the photoconductive drum 11 is transferred to the paper S by the transfer roller 15. The paper S on which the toner image is transferred is conveyed to the fixing device 19 and heated and pressed by the fixing device 19 to fix the image on the paper S. The paper S on which the image is fixed is discharged to the paper discharge tray 36 through the paper discharge roller 35.

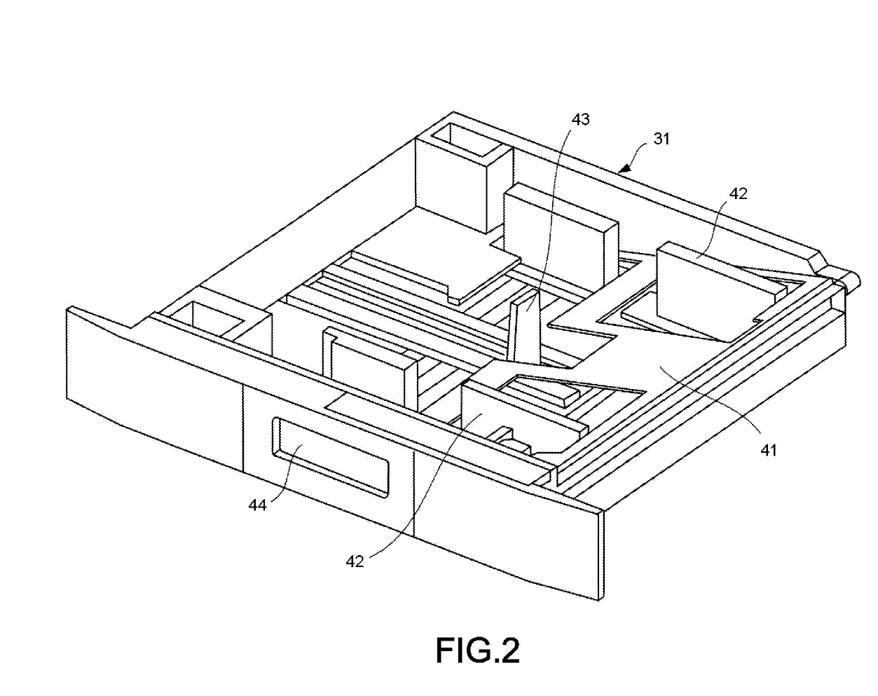

FIG. 2 is a perspective view illustrating the paper feed cassette 31. The paper feed cassette 31 is provided with a tray 41 for stacking the paper S. The tray 41 is inclined obliquely. Side guides 42 which are used to align the two sides of the paper S are arranged inside the tray 41. An end guide 43 for aligning the rear end of the paper S is also arranged inside the tray 41. The cassette 31 also includes a handle 44 for pulling out the cassette 31 from the main body of the image forming apparatus 100. The end guide 43 is capable of moving according to the size of paper.

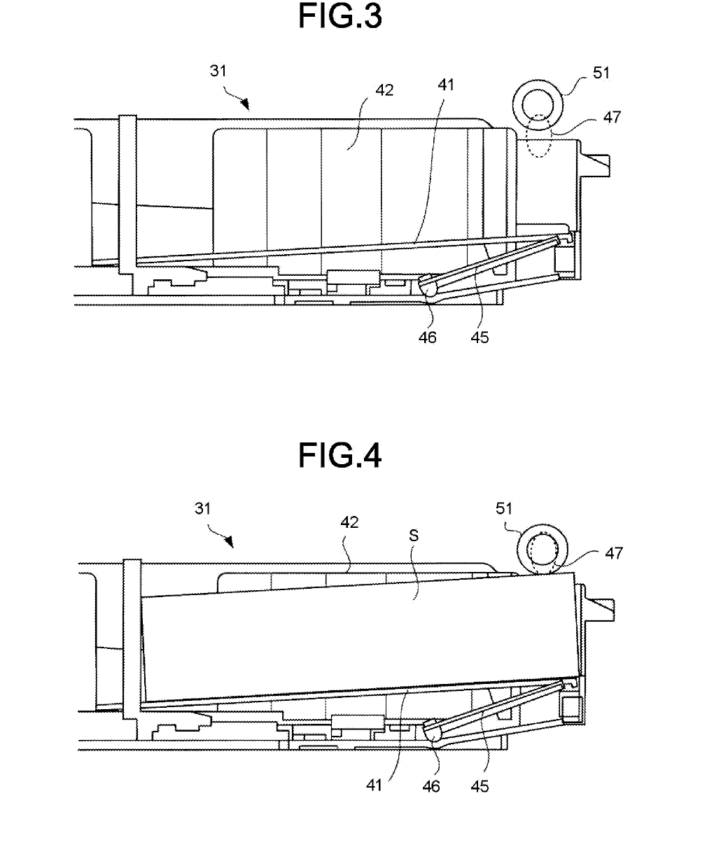

FIG. 3 and FIG. 4 are side views of the cassette 31. FIG. 3 illustrates a state before stacking the paper S in the cassette 31. FIG. 4 illustrates a state after stacking the paper S in the cassette 31. In FIG. 3, there is a lever 45 which is arranged at the underside of the tray 41 inside the cassette 31 to lift the tray 41. The lever 45 is rotated taking a shaft 46 as a fulcrum. The lever 45 lifts the tray 41, and in this way, the top surface of the paper S stacked in the tray 41 is in contact with the pickup roller 51.

Further, an empty sensor 47 is arranged nearby the pickup roller 51 of the cassette 31. The empty sensor 47 detects that the paper in the tray 41 is run out. For example, a hole (not shown) is drilled in the tray 41 in advance, and a light source and the empty sensor 47 are arranged taking the hole as a center. In a case in which the empty sensor 47 detects the light from the light source passing through the hole, the empty sensor 47 detects that there is no paper in the tray 41. If there is the paper Sin the tray 41, the hole arranged in the tray 41 is blocked by the paper. Thus, the light from the light source will not pass through the hole. As a result, the empty sensor 47 detects that there is paper in the tray 41.

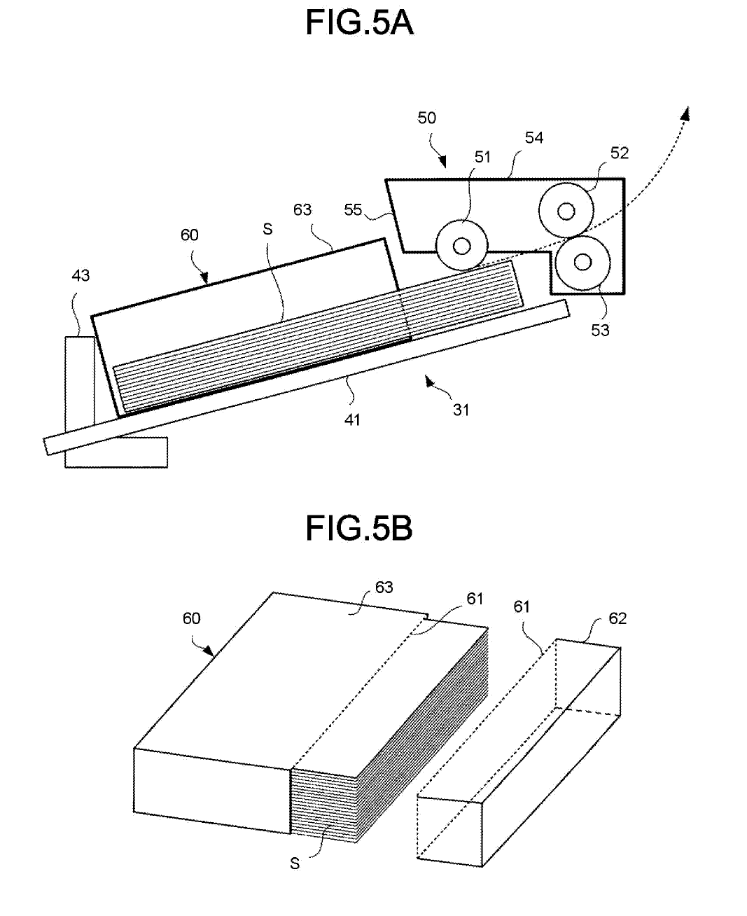

FIG. 5A is a side view illustrating the constitutions of a paper feed section 50 and the cassette 31 of the image forming apparatus according to the embodiment. Further, FIG. 5B is a perspective view illustrating the constitutions of the paper S and a packaging member 60 for packaging the paper S.

As shown in FIG. 5B, the paper S is housed in the packaging member 60 such as the packing paper and the like. An annular perforation 61 is formed at the front end part of the packaging member 60 in a conveyance direction of the paper S. Moreover, the perforation 61 is just described as an example. In addition to the perforation, a cut such as a slit and the like formed intermittently may be formed. In a word, as long as it can encourage the opening of one end part of the packaging member 60, it may be any form but not limited to the perforation 61.

When setting the paper S in the cassette 31, the front end part 62 of the packaging member 60 is opened along the perforation 61. In FIG. 5B, a state in which the front end part 62 of the packaging member 60 is opened is illustrated. After the front end part 62 is opened, the packaging member 60 is set in the tray 41 with housing the paper S in the main body part 63 thereof. Further, after the front end part 62 of the packaging member 60 is removed, the end of the paper S is exposed from the opened end of the packaging member 60. Thus, the main body part 63 after opening the front end part 62 is formed in such a shape that the exposed end of the paper S can be contacted with the pickup roller 51 and the sensing operation (transmission of light) in the empty sensor 47 is not interfered with. That is, the empty sensor 47 detects whether or not there is the paper S exposed from the opened end of the packaging member 60.

In FIG. 5A, the packaging member 60 the front end part 62 of which is removed is set in the tray 41. The end of the paper S which is housed in the main body part 63 of the packaging member 60 is contacted with the pickup roller 51.

The paper feed section 50 includes the pickup roller 51 for picking up the paper S from the cassette 31. The paper feed section 50 further includes paper feed rollers 52 and 53 for conveying the paper picked up by the pickup roller 51.

The pickup roller 51, which is contacted with the front end of the paper S in the tray 41, rotates itself to pick up the paper S. The paper S picked up by the pickup roller 51 is conveyed to the paper feed rollers 52 and 53. In a case in which more than two sheets of paper are picked up by the pickup roller 51, the paper feed roller 53 separates the paper one by one and then conveys them to the subsequent stage. Therefore, the paper feed roller 53 is also referred to as a separation roller. The paper feed rollers 52 and 53 are arranged opposite to each other. The paper is conveyed towards the conveyance roller 32 (FIG. 1) through the rotation of the paper feed rollers 52 and 53.

The paper feed section 50 is further provided with a housing 54 in which the pickup roller 51, the paper feed rollers 52 and 53 are arranged. Moreover, a stopper 55 is arranged at the side of the housing 54 facing the cassette 31. The stopper 55 is a regulating member for regulating the conveyance of the packaging member 60 from the tray 41. The stopper 55 is opposed to the main body part 63 of the packaging member 60.

As the paper S is sequentially fed from the cassette 31, the remaining amount of the paper becomes less and less. When it comes to the final paper due to the reduction of the remaining amount of the paper, there is a case where the packaging member 60 hung on the paper S is conveyed in the conveyance direction of the paper. The stopper 55 is arranged to regulate the conveyance of the packaging member 60.

If the paper S in the tray 41 is reduced, an up operation is carried out for the tray 41 by the lever 45 (FIG. 4). The packaging member 60 is also lifted up, and the part corresponding to the perforation 61 is opposed to the stopper 55.

Thus, even if the packaging member 60 is likely to be conveyed from the tray 41 along with the conveyance of the paper S, the front end of the packaging member 60 hits the stopper 55. The packaging member 60 is regulated by the stopper 55, thereby preventing the packaging member 60 from being conveyed from the tray 41.

### A Second Embodiment

In the second embodiment, another constitution of a regulating member for regulating the conveyance of the packaging member 60 placed in the tray 41 is described. In the second embodiment, the rear end of the packaging member 60 (the end in a direction opposite to the paper conveyance direction) is held to regulate the conveyance.

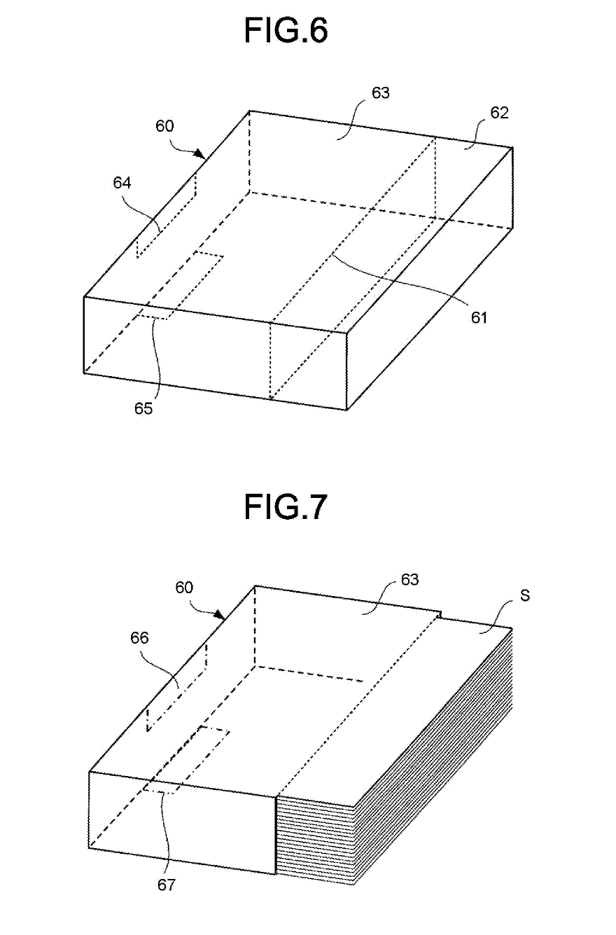

FIG. 6 and FIG. 7 illustrate a modification of the packaging member 60. In FIG. 6, the paper S is housed in the packaging member 60 such as the packing paper and the like. At the front end part of the packaging member 60 in the conveyance direction of the paper S, the perforation 61 is formed to make it possible for easy opening of the front end part of the packaging member 60. Further, at the upper portion of the rear end of the packaging member 60 and on the bottom surface connected with the rear end are formed perforations 64 and 65 in a square shape respectively. When setting the paper S in the cassette 31, the front end part 62 of the packaging member 60 is opened along the perforation 61. In addition, the parts corresponding to the perforations 64 and 65 are cut.

In FIG. 7, a state in which the front end part 62 of the packaging member 60 is opened along the perforation 61 is illustrated. The front end part of the paper S is exposed. The parts corresponding to the perforations 64 and 65 are cut, and therefore, a hole 66 is formed at the upper portion of the rear end of the packaging member 60, and a hole 67 in a square shape is formed on the bottom surface connected with the rear end of the packaging member 60.

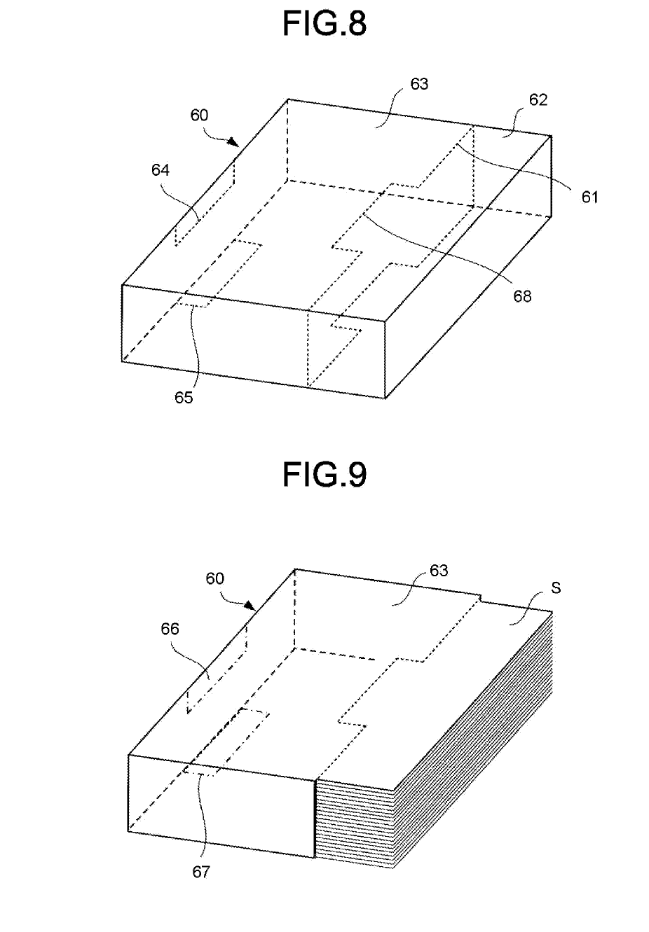

FIG. 8 and FIG. 9 illustrate another modification of the packaging member 60. In FIG. 8, the shape of the perforation 61 at the front end part of the packaging member 60 is slightly different from that in FIG. 6. That is, a perforation 68 is added in such a manner that the central part of the perforation 61 is cut in a direction opposite to the conveyance direction of the paper S. Further, at the upper portion of the rear end of the packaging member 60 and on the bottom surface connected with the rear end are formed perforations 64 and 65 in a square shape respectively. When setting the paper S in the cassette 31, the front end part 62 of the packaging member 60 is opened along the perforations 61 and 68. In addition, the parts corresponding to the perforations 64 and 65 are cut.

In FIG. 9, a state in which the front end part 62 is opened along the perforations 61 and 68 is illustrated. The front end part of the paper S is exposed. The exposure of the part corresponding to the perforation 68 on the paper S is increased, and therefore, it becomes easier for the pickup roller 51 to be in contact with the paper S. The parts corresponding to the perforations 64 and 65 are cut, and therefore, a hole 66 is formed at the upper portion of the rear end of the packaging member 60, and a hole 67 in a square shape is formed on the bottom surface connected with the rear end of the packaging member 60.

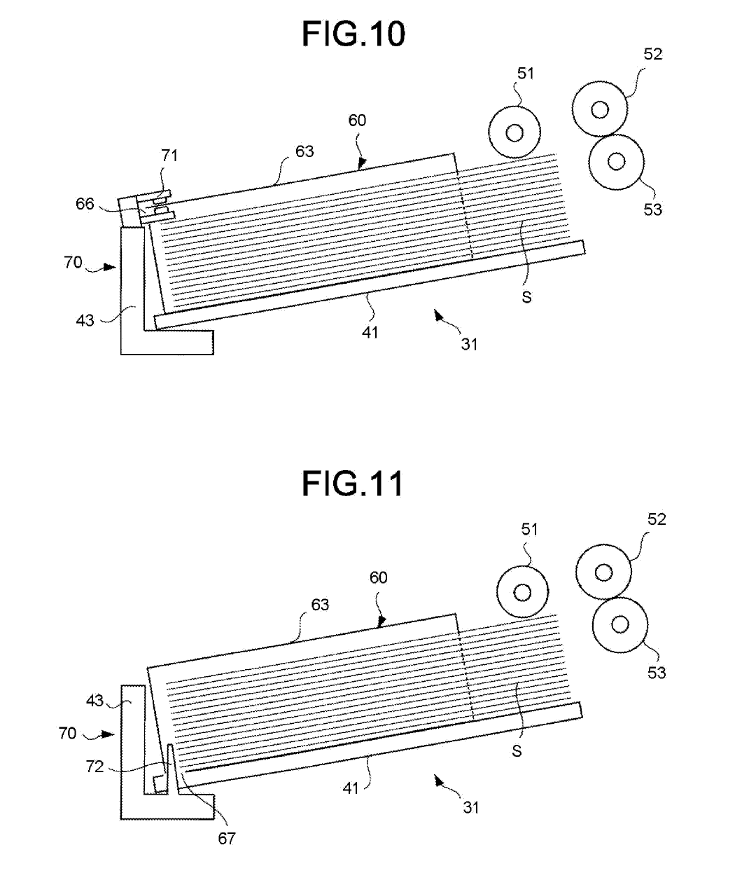

FIG. 10 is a side view illustrating the cassette 31 provided with a regulating member 70 for regulating the conveyance of the packaging member 60. In FIG. 10, a state in which the packaging member 60 (shown in FIG. 7 or FIG. 9) the front end part 62 of which is opened is placed in the tray 41 is illustrated.

In order to prevent the packaging member 60 from being conveyed along with the feeding of the paper S, the regulating member 70 is arranged. The regulating member 70 includes a holding mechanism 71 arranged in the end guide 43 at the rear end of the tray 41.

The holding mechanism 71 enters the square-shaped hole 66 formed by cutting the part corresponding to the perforation 64 to hold the rear end of the packaging member 60. Thus, even if the paper S is picked up from the packaging member 60 and the packaging member 60 is likely to be conveyed from the tray 41, the rear end of the packaging member 60 is held by the holding mechanism 71. In this way, the conveyance of the packaging member 60 from the tray 41 can be regulated.

FIG. 11 illustrates a side view illustrating the cassette 31 provided with a regulating member 70 for regulating the conveyance of the packaging member 60. In FIG. 11, a state in which the packaging member 60 (shown in FIG. 7 or FIG. 9) the front end part 62 of which is opened is placed in the tray 41 is illustrated. The regulating member 70 includes a projection 72 formed on the bottom surface of the end guide 43 at the rear end of the tray 41. The projection 72 enters the square-shaped hole 67 formed by cutting the part corresponding to the perforation 65 to insert into the rear end of the packaging member 60.

Thus, even if the packaging member 60 is likely to be conveyed from the tray 41, the projection 72 has entered the rear end of the packaging member 60. In this way, the conveyance of the packaging member 60 from the tray 41 can be regulated.

In accordance with the image forming apparatus according to the embodiments described above, it is possible to set the paper in the cassette for each packaging member. In this way, the setting of paper can be easily carried out without troubling the user. Further, no setting failure of paper causes, and the position deviation of an image formed on the paper or the paper jam can be reduced, thus, the conveyance of the packaging member can be regulated through the regulating member.

However, the present invention is not limited to the embodiments described above, and various kinds of applications can be applied. For example, the shape of the perforation formed in the packaging member is not limited to the example exemplified in the figures, and it may also be the other shapes. Further, in addition to forming the perforation, it may be a structure in which the front end part can be easily removed such as forming a cut and the like.

Further, the embodiment can be applied to an image forming apparatus different from the image forming apparatus in FIG. 1. For example, it may be an image forming apparatus having a developing unit for a plurality of colors, like a quadruple-tandem image forming apparatus. Further, the exposure unit 13 having a laser light source can be replaced by a scanning head including the LED element.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image forming apparatus, comprising:
a paper feed cassette configured to include a tray which is capable of placing the paper housed in a packaging member one end of which is opened together with the packaging member;
a paper feed section configured to include a pickup roller which picks up the paper housed in the packaging member from the opened end of the packaging member;
a regulating member configured to regulate that the packaging member is conveyed from the tray; and
an image forming section configured to form an image on the paper conveyed by the paper feed section.

2. The image forming apparatus according to claim 1, wherein
the regulating member is a stopper arranged in a housing in which the pickup roller is arranged at a position opposite to the opened end of the packaging member; and
the packaging member is regulated to be conveyed from the tray by the stopper.

3. The image forming apparatus according to claim 2, further comprising:
a lever configured in the paper feed cassette to lift the tray to contact the paper with the pickup roller, wherein
the stopper is arranged at a position facing the packaging member in the tray lifted by the lever.

4. The image forming apparatus according to claim 2, wherein
the paper feed section includes a pair of paper feed rollers arranged in the housing for conveying the paper picked up by the pickup roller to the image forming section.

5. The image forming apparatus according to claim 1, wherein
one end of the packaging member is opened, and at the other end of the packaging member is formed a hole; and
the regulating member is a holding mechanism arranged in an end guide at the rear end of the tray to enter the hole to hold the other end of the packaging member.

6. The image forming apparatus according to claim 1, wherein
one end of the packaging member is opened, and a hole is formed on a bottom surface connecting with the other end of the packaging member; and
the regulating member is a projection arranged in an end guide at the rear end of the tray to enter the hole to regulate the conveyance of the packaging member.

7. The image forming apparatus according to claim 1, wherein
a cut is formed at the one end of the packaging member to encourage the opening of the one end.

8. The image forming apparatus according to claim 1, wherein
an annular perforation is formed at the one end of the packaging member to encourage the opening of the one end.

9. The image forming apparatus according to claim 8, wherein
the perforation is formed in the packaging member in such a shape that the pickup roller can be contacted with the paper exposed from the opened end of the packaging member.

10. The image forming apparatus according to claim 1, further comprising:
an empty sensor configured to detect that the paper in the tray is run out, wherein
the empty sensor detects whether or not there is the paper exposed from the opened end of the packaging member.
